(19) United States
(12) Patent Application Publication
(10) Pub. No.: US 2010/0075587 A1
(43) Pub. Date: Mar. 25, 2010

(54) APPARATUS HAVING A CLOSED-OFF WORK CHAMBER WITH IMPROVED CLEANABILITY

(76) Inventors: Thomas HERTFELDER, Frankenhardt (DE); Bernhard Sippel, Crailsheim (DE); Thomas Mack, Crailsheim (DE); Rolf Daeuber, Braunsbach (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/545,990

(22) Filed: Aug. 24, 2009

(30) Foreign Application Priority Data
Aug. 25, 2008 (DE) 10 2008 041 521.9

(51) Int. Cl. B08B 15/02

(52) U.S. Cl. 454/66

(57) ABSTRACT

The invention relates to an apparatus, in particular for processing toxic and/or medical media, including a closed-off work chamber, in which the medium can be manipulated. A ventilating device delivers a particle-free or laminar or turbulent air stream to the work chamber. A return air conduit communicates with the work chamber via an outlet opening and by way of which air is carried away from the work chamber. A cleaning element is disposed in the work chamber, to enable cleaning of the work chamber and of the return air conduit. At least one blocking device blocks off an additional connecting portion between the work chamber and the return air conduit. The blocking device is able to be opened for cleaning of the return air conduit.

### CROSS-REFERENCE TO RELATED APPLICATION

This application is based on German Patent Application 10 2008 041 521.9 filed Aug. 25, 2008.

### BACKGROUND OF THE INVENTION

1. Field of the Invention

The present invention relates to an apparatus having a closed-off work chamber, in particular for processing toxic media.

2. Description of the Prior Art

An apparatus with a closed-off work chamber is known from the prior art, as an “isolator” among other things. Such devices are used particularly in medical technology for putting medications in containers. Such devices are thoroughly rinsed with a particle-free or laminar or turbulent air stream, so that the medications or other media can be processed particle-free. For returning the introduced air stream, a return air conduit is typically used, on the end of which a filter is disposed. After a batch of the medium has been put in containers, the apparatus must typically be cleaned from the inside. For that purpose, it is known to perform cleaning using a spray gun, which is disposed in the interior of the apparatus, with the aid of manipulating gloves. However, a problematic aspect is particularly the cleaning of the return air conduit, since the return air conduit communicates with the closed-off work chamber of the apparatus only via an outlet opening. It has therefore been proposed that spray devices that clean the return air conduit be provided in such return air conduits. It has been found that the decontamination of the isolator that must be done after cleaning and is understood also to have to be done in the return air conduit is often inadequate to reach internal regions of the spray devices. It can therefore happen that some of the toxic medium is still present in the spray devices in the return air conduit, so that it is possible for a subsequent batch to be contaminated or for the worker to be contaminated during servicing tasks. Another alternative would be to provide an access in the return air conduit that would enable cleaning from the outside. However, that would mean that the return air conduit has to be opened, which can be done only under conditions of full protection for the worker, to avoid contaminating the worker with poisonous substances. Another disadvantage is that the closed-off apparatus is opened into a space with a lower classification, so that the possibility exists that the apparatus will be contaminated.

### ADVANTAGES AND SUMMARY OF THE INVENTION

The apparatus of the invention has the advantage over the prior art that safe and effective cleaning of both the apparatus and a return air conduit is possible. In the apparatus of the invention, there is not the danger that additional parts or the closed-off inner chamber will become contaminated. This is attained according to the invention in that at least one additional connecting point between a closed-off work chamber of the apparatus and a return air conduit is provided, which is closed by means of a blocking device. When cleaning of the apparatus is necessary, the blocking device is opened, and the return air conduit can be cleaned by passing a cleaning element through the opened connecting point. It should be noted that the connecting point according to the invention is provided in addition to an outlet opening in the work chamber, by way of which opening a constant communication of the work chamber with the return air conduit for assuring the flow through the work chamber during the use of the work chamber is possible. Thus according to the invention, the return air conduit as well can be cleaned quickly and simply as needed, so that there is no danger that an ensuing work step will be contaminated with particles from the return air conduit.

Especially preferably, the blocking device includes a membrane which is destroyed for cleaning of the return air conduit. In other words, the membrane is for instance pierced by the cleaning element and damaged, so that the cleaning element can be introduced into the return air conduit via the connecting point. The destruction of the membrane has the advantage in particular that a worker who has to perform the cleaning is visually shown that, if the membrane is destroyed, he has already performed the cleaning. As the membrane, a thin metal membrane is especially preferably used. Before the next work step, the destroyed membrane is then replaced, after the apparatus is cleaned, with an intact membrane.

To enable simple, fast replacement of a destroyed membrane with an intact membrane, a bayonet mount is preferably provided, and the membrane is preferably fixed by being clamped in place.

In an alternative feature of the present invention, the blocking device includes a membrane which has at least one slit. For cleaning the return air conduit, the cleaning element is introduced through the slit in the membrane, without destroying the membrane in the process. Once again, safe and effective cleaning of the return air conduit can be obtained as a result. It is especially advantageous that the membrane that has the slits does not have to be replaced. However, in that case the worker is also not informed whether he has already cleaned the return air conduit in this region, since after the cleaning element is withdrawn, the membrane returns to its original outset state. The slit membrane preferably has a cross-shaped slit and is made from a rubber material.

In another alternative feature of the present invention the blocking device is disposed detachably at the connecting point to the return air conduit. As a result, once again a blocking device is furnished which need not be destroyed for cleaning. To clean the return air conduit, the blocking device must merely be detached from the connecting point. This can be done for instance by the provision of a blocking device in the form of a cap which can for instance be unhooked from a closed position. Alternatively, the blocking device can be opened by rotating or pulling it or the like. To prevent the caplike blocking device from being lost, the caplike blocking device is preferably joined to a wall of the work chamber preferably by means of a connecting element, in particular a cord or chain or hinge. As a result, the caplike blocking device hangs securely on the wall of the work chamber and cannot be lost in a cleaning operation. Another advantage of the caplike blocking device that can be named is that this provides visual monitoring for a worker as to whether this portion of the return air conduit has already been cleaned, or not.

Preferably, the cleaning element is a spray gun with a preferably long rifle-like barrel. Also preferably, a mandrel or the like is disposed on the free end of the cleaning element, to make it simple to pierce the membrane or punch it open.

Also preferably, a plurality of connecting points are provided between the closed-off work chamber and the return air conduit. The many work chambers are preferably all provided with the same blocking devices and preferably disposed at equal spacings from one another.

### BRIEF DESCRIPTION OF THE DRAWING

The invention will be better understood and further objects and advantages thereof will become more apparent from the ensuing detailed description of a preferred embodiment taken in conjunction with the drawing, in which:

FIG. 1 is a schematic view of an apparatus having a closed-off work chamber, in accordance with an exemplary embodiment of the invention.

### DESCRIPTION OF THE PREFERRED EMBODIMENT

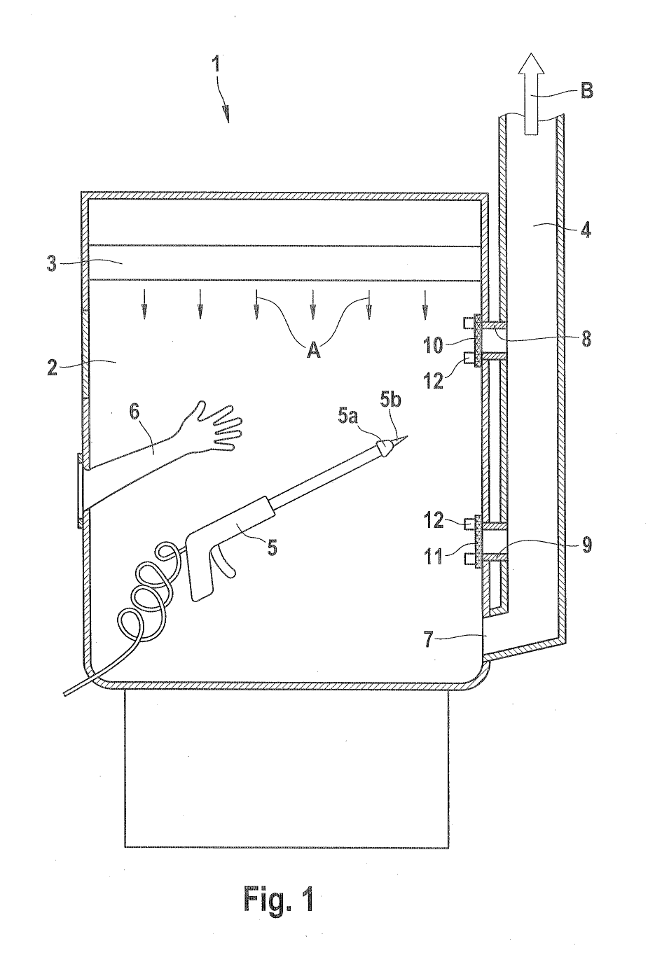

Below, in conjunction with FIG. 1, an apparatus (isolator) with a closed-off work chamber 2 will be described in detail.

As can be seen from FIG. 1, the apparatus 1 includes a closed-off work chamber 2, in which a toxic medium, for instance, is put into containers. The apparatus 1 includes a ventilating device 3, which assures that a particle-free laminar air stream is passed through the work chamber 2. This is indicated in FIG. 1 by the small arrows A. The apparatus 1 further includes a return air conduit 4, which communicates with the work chamber 2 via an outlet opening 7. Via the outlet opening 7, the air flows out of the work chamber 2 into the return air conduit 4 and from there, via a filter, not shown, it flows back out of the apparatus 1 again. This is indicated in FIG. 1 by the arrow B.

The apparatus 1 further includes a spray gun 5, which serves to clean both the work chamber 2 and the return air conduit 4. The spray gun 5 is operated from outside the apparatus 1 by a worker, not shown, by means of a manipulating glove 6. A first connecting portion 8 and a second connecting portion 9 are also provided between the work chamber 2 and the return air conduit 4. The two connecting portions are embodied as tubular, cylindrical connecting tubes; a first blocking device 10 closes the first connecting portion 8, and a second blocking device 11 closes the second connecting portion 9. The blocking devices 10, 11, in this exemplary embodiment, are metal membranes, which are each held on an inner wall of the work chamber 2 by means of a bayonet mount 12. During a use of the closed-off work chamber 2, the two blocking devices 10, 11 are likewise closed.

Once a batch of a medication, for instance, has been put in containers in the work chamber 2, cleaning of both the work chamber 2 and the return air conduit 4 must be done. To that end, a worker reaches into the manipulating glove 6 and cleans the interior by means of the spray gun 5. A spray head 5a is disposed on the end of the spray gun 5, and a mandrel 5b is also provided on the spray head. Cleaning fluid can be sprayed from the spray head 5a, and the mandrel 5b serves to pierce the first and second blocking devices 10, 11. Thus the return air conduit 4 can be cleaned by means of the spray gun 5 via the first and second connecting portions 8, 9 as well as the outlet opening 7. Since for the cleaning the first and second blocking devices 10, 11 embodied as membranes have to be damaged, a worker knows precisely whether he has already cleaned this region of the return air conduit 4, or not. After a cleaning, the first and second blocking devices 10, 11 are replaced with new ones, so that in the next work step, no additional communication between the work chamber 2 and the return air conduit 4 is provided. It can thus be assured that the laminar flow A again flows past the working devices in the work chamber 2, as planned.

Thus by the piercing of the membranes at the first and second connecting portions 8, 9, it can be assured that a worker also cleans all the regions of the apparatus 1. In a cleaning operation, each time only the membranes have to be replaced with new ones. Since a bayonet mount 12 is provided, replacement of the membranes can be done quickly and without interruption. The old membranes and the new membranes can be introduced into the work chamber 2 via a lock, not shown.

To make further-simplified cleaning possible, it should also be noted that the spray gun 5 may for instance also be embodied in telescoping fashion, and that the spray gun 5 can furthermore have a quick-change system on the spray head 5a, for attaching different spray heads.

The foregoing relates to a preferred exemplary embodiment of the invention, it being understood that other variants and embodiments thereof are possible within the spirit and scope of the invention, the latter being defined by the appended claims.

We claim:

1. An apparatus, in particular for processing a toxic and/or medical medium, comprising
a closed-off work chamber, in which the medium can be manipulated;
a ventilating device, which delivers a particle-free or laminar or turbulent air stream to the work chamber;
a return air conduit, which communicates with the work chamber via an outlet opening and by way of which air is carried away from the work chamber;
a cleaning element, which is disposed in the work chamber, to enable cleaning of the work chamber and of the return air conduit; and
at least one blocking device, which blocks off an additional connecting portion between the work chamber and the return air conduit, wherein the blocking device is able to be opened for cleaning of the return air conduit.

2. The apparatus as defined by claim 1, wherein the blocking device includes a membrane which is embodied as destructible for cleaning of the return air conduit.

3. The apparatus as defined by claim 2, wherein the membrane is a metal membrane.

4. The apparatus as defined by claim 2, wherein the membrane is disposed replaceably.

5. The apparatus as defined by claim 3, wherein the membrane is disposed replaceably.

6. The apparatus as defined by claim 1, wherein the blocking device includes a membrane having a slit, and for cleaning of the return air conduit, the cleaning element can be inserted through the slit without destroying the membrane.

7. The apparatus as defined by claim 6, wherein the membrane is slit in crosslike fashion.

8. The apparatus as defined by claim 1, further comprising a caplike blocking device, which is disposed detachably on the connecting portion between the work chamber and the return air conduit.

9. The apparatus as defined by claim 2, further comprising a caplike blocking device, which is disposed detachably on the connecting portion between the work chamber and the return air conduit.

10. The apparatus as defined by claim 3, further comprising a caplike blocking device, which is disposed detachably on the connecting portion between the work chamber and the return air conduit.

11. The apparatus as defined by claim 6, further comprising a caplike blocking device, which is disposed detachably on the connecting portion between the work chamber and the return air conduit.

12. The apparatus as defined by claim 8, wherein the caplike blocking device is connected to a wall of the work chamber by means of a connecting element, in particular a cord or chain or hinge, to prevent the caplike blocking device from disconnecting from the wall.

13. The apparatus as defined by claim 9, wherein the caplike blocking device is connected to a wall of the work chamber by means of a connecting element, in particular a cord or chain or hinge, to prevent the caplike blocking device from disconnecting from the wall.

14. The apparatus as defined by claim 11, wherein the caplike blocking device is connected to a wall of the work chamber by means of a connecting element, in particular a cord or chain or hinge, to prevent the caplike blocking device from disconnecting from the wall.

15. The apparatus as defined by claim 1, wherein the cleaning element is a spray gun, in particular with a replaceable spray head.

16. The apparatus as defined by claim 6, wherein the cleaning element is a spray gun, in particular with a replaceable spray head.

17. The apparatus as defined by claim 1, wherein a mandrel is disposed on one free end of the cleaning element.

18. The apparatus as defined by claim 16, wherein a mandrel is disposed on one free end of the cleaning element.

19. The apparatus as defined by claim 1, wherein a plurality of connecting portions are disposed between the work chamber and the return air conduit.

20. The apparatus as defined by claim 18, wherein a plurality of connecting portions are disposed between the work chamber and the return air conduit.
